(19) United States
(12) Patent Application Publication
(10) Pub. No.: US 2014/0025471 A1
(43) Pub. Date: Jan. 23, 2014

(54) Consumer Health Incentive Program

(71) Applicant: Safeway Inc., Pleasanton, CA (US)

(72) Inventors: Kent L. BRADLEY, Pleasanton, CA (US); Brad WOLFSEN, Pleasanton, CA (US)

(73) Assignee: Safeway Inc., Pleasanton, CA (US)

(21) Appl. No.: 13/943,600

(22) Filed: Jul. 16, 2013

Related U.S. Application Data
(60) Provisional application No. 61/674,504, filed on Jul. 23, 2012.
(60) Provisional application No. 61/783,569, filed on Mar. 14, 2013.

(51) Int. Cl. G06Q 30/02

(52) U.S. Cl. CPC G06Q 30/0226; G06Q 30/0234
USPC 705/14.27; 705/14.1; 705/14.34

(57) ABSTRACT

A computer implemented system for sustaining healthcare consumerism. The computer implemented system comprises a database, wherein the database contains pricing information for a medical service, a reference price for the medical service, an application configured to determine the reference price for the medical service, and an incentive engine configured to incentivize a policy holder to obtain the medical service at a price lower than the reference price for the medical service.

### CROSS-REFERENCE TO RELATED APPLICATIONS

This application claims priority to U.S. Provisional Patent Application Ser. Nos. 61/674,504 filed Jul. 23, 2012 and entitled “Safeway's Consumer Health Incentive Program (S-CHIP),” and 61/783,569 filed Mar. 14, 2013 and entitled “Consumer Health Incentive Program,” each of which is incorporated by reference herein in its entirety.

### BACKGROUND

Employers may provide health insurance to employees. Plans may vary with regard to covered procedures, drugs, health aids, medical examinations, coverage amounts, etc. Some plans may include an annual individual and/or family deductible that is satisfied before benefit payments are made. Some procedures may be paid at a percentage and the remainder paid by the insured. For example, a major diagnostic procedure may be paid 80% by insurance and 20% by the insured, after the annual deductible is satisfied. The insured, having a stake in the costs, may moderate his/her usage accordingly.

### SUMMARY

In an embodiment, a computer implemented system for sustaining healthcare consumerism is disclosed. The system comprises a database, wherein the database contains pricing information for a medical service, a reference price for the medical service, an application configured to determine the reference price for the medical service, and an incentive engine configured to incentivize a policy holder to obtain the medical service at a price lower than the reference price for the medical service.

In an embodiment, a computer implemented method for sustaining healthcare consumerism is disclosed. The method comprises compiling pricing information about a range of prices charged for a medical service by a plurality of medical service providers, establishing a reference price for the medical service based at least in part on the pricing information for the medical service, analyzing a price differential between the reference price for the medical service and a price a policy holder paid for the medical service, and providing a rebate to the policy holder when the analysis indicates that the policy holder obtained the medical service at a price lower than the reference price for the medical service, wherein the rebate is determined at least in part by the price differential between the reference price for the medical service and the price the policy holder paid for the medical service.

In an embodiment, a computer implemented system for managing healthcare costs is disclosed. The system comprises a database, wherein the database contains pricing information for a medical service, a reference price for the medical service, an algorithm configured to establish the reference price for the medical service, an application configured to perform the algorithm, and an incentive configured to incentivize a policy holder to obtain the medical service at a price lower than the reference price for the medical service.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying figures and detailed description, wherein like reference numerals represent like parts.

FIG. 1 is an illustration of a computer according to an embodiment of the disclosure.

FIG. 2 is an illustration of a system according to an embodiment of the disclosure.

FIG. 3 is a flowchart of a method according to an embodiment of the disclosure.

FIG. 4 is a flowchart of a method according to an embodiment of the disclosure.

FIG. 5 is a flowchart of a method according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

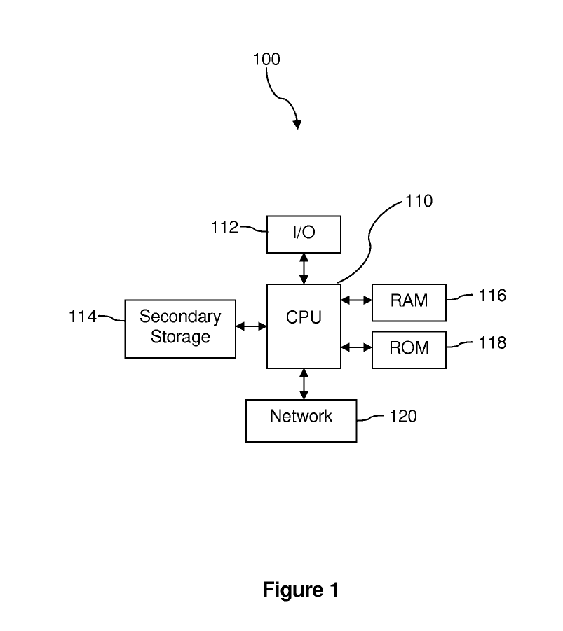

Turning now to FIG. 1, FIG. 1 illustrates a computer system 100 suitable for implementing one or more embodiments disclosed herein. The computer system 100 includes a processor 110 (which may be referred to as a central processor unit or CPU) that is in communication with memory devices including secondary storage 114, read only memory (ROM) 118, random access memory (RAM) 116, input/output (I/O) devices 112, and network connectivity devices 120. The processor 110 may be implemented as one or more CPU chips. The computer system 100 may further comprise an application and/or a plurality of applications executable by the processor 110.

In an embodiment, the computer system 100 may be used in a system and/or method for managing healthcare costs associated with providing healthcare to policy holders. The application and/or the plurality of applications of the computer system 100 may be configured to operate in the system and/or method for managing healthcare costs. In some contexts, managing healthcare costs may be referred to as reducing healthcare costs, maintaining healthcare consumerism, or limiting expenditures. The system and/or method for managing healthcare costs associated with providing healthcare to policy holders may be implemented by an employer, an insurance company, or another entity. For example, an employer seeking to manage healthcare costs associated with providing healthcare to policy holders may use the computer system 100 to keep track of data pertinent to the healthcare plans of its employees that are policy holders.

In some contexts, policy holders may be referred to as consumers, the insured, health plan members, clients, customers, or they may be referred to as another term. For the purposes of this disclosure, individuals receiving healthcare benefits will be referred to as policy holders. In an embodiment, an entity, such as an enterprise or company, may observe that policy holders of its healthcare plan are not price conscious after they are out of the deductible phase of their healthcare plan, i.e., policy holders have met their deductibles for the current plan period based on previous healthcare plan expenditures during the current plan period. Upon such occurrence, the entity may limit its healthcare plan expenditures for medical services if the policy holders purchase medical services from providers offering said services at rates below rates offered by other similarly situated/located providers. It should be understood that the terms “medical services,” “healthcare services,” “healthcare,” and “medical care” are not intended to limit the scope of the present disclosure but rather may encompass all manner of medical procedures, examinations, tests, prescriptions, health aids, and emergency services.

The entity, e.g., healthcare plan, healthcare plan manager, healthcare plan owner, may determine a reference price for a given medical service and agree to pay up to that price once a policy holder is past the deductible phase of his/her healthcare plan. In some cases, the reference price may be determined by an algorithm configured to calculate an acceptable price for a medical service based upon a range of known prices charged by medical service providers for the medical service, an economic parameter, based upon a desired quality for the medical service, or upon combinations thereof. In other cases, the reference price may be determined based upon other factors.

If the policy holder purchases healthcare service at a price less than the reference price for that service, then the entity may experience a reduction in costs associated with providing healthcare benefits as compared to the same healthcare services being purchased at or above the referenced price; however, if the policy holder purchases healthcare services at or above the reference prices for those services, then the entity may realize the maximum cost associated with providing healthcare to the policy holder. Policy holders that are not in the deductible phase of their healthcare plan may not have any motivation to look for cost efficient healthcare services. Thus, policy holders outside of the deductible phase of their healthcare plan may choose more expensive healthcare options than they would if they were in the deductible phase of their healthcare plan.

In order to manage healthcare costs associated with providing healthcare to policy holders, the entity may provide an incentive to entice policy holders to be more conservative when shopping for healthcare. In an embodiment, the incentive may be in the form of a shared savings rebate, wherein shared savings may refer to sharing a portion of the savings that the entity realizes when the policy holder purchases a medical service below the reference price for that service. When the incentive is a shared savings rebate, the policy holder may receive cash back for purchasing the medical service below the reference price. The amount the policy holder receives from the shared savings rebate may be a percentage of the savings, attributable to the policy holder shopping below the reference price, that the entity experiences, it may be a fixed amount, or it may be some other amount.

In an embodiment, the shared savings rebate may involve the policy holder receiving a monetary amount corresponding to a percentage of the price differential between the reference price for a medical service and the price the policy holder paid for the medical service. In this case, the percentage of the price differential that the policy holder receives as a rebate may be about 20%. In other cases, the percentage of the price differential that the policy holder receives as a rebate may be about 30%. In other cases, the percentage of the price differential that the policy holder receives as a rebate may be about 40%. In other cases, the percentage of the price differential that the policy holder receives as a rebate may be about 5%, 10%, 20%, 30%, 40%, 50%, 60%, 70%, 80%, 90% or some other percentage. The shared savings rebate may be used to entice policy holders to obtain medical care at lower costs.

The entity may use the computer system 100 to keep track of the reference price and/or the price charged by medical service providers for a medical service or a plurality of medical services. The entity may also use the computer system 100 to determine the reference price for a medical service, calculate the difference between a price paid by the policy holder and the reference price, determine a rebate, apply the rebate, store information about the policy holder, store information about an incentive plan, store information about an incentive engine, store information about an incentive, or to perform another task associated with managing healthcare costs. In an embodiment, the computer system 100 may invoke the application and/or the plurality of applications to facilitate completion of the tasks enumerated hereinabove.

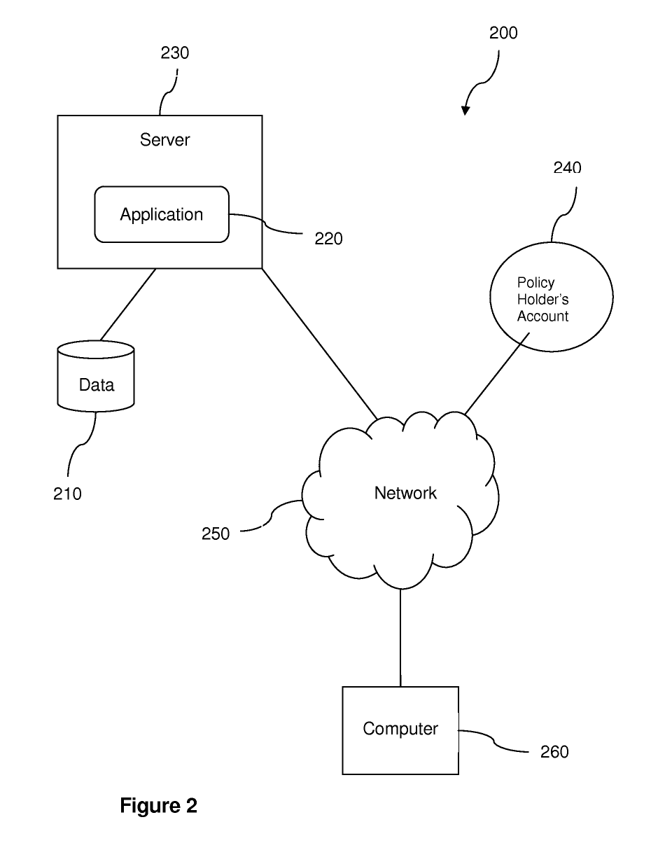

Turning now to FIG. 2, FIG. 2 illustrates a healthcare management system 200. The healthcare management system 200 comprises a server 230, an application 220, a database 210, a network 250, a computer 260, and an account 240. Though the server 230 is depicted as comprising only the application 220, it will be readily appreciated by an artisan that the server 230 may comprise a plurality of applications and may perform a variety of functions.

The application 220 may be configured to determine the reference price for a medical service. The application 220 may invoke one or more algorithms in order to determine the reference price or in order to accomplish other tasks. For example, the application 220 may invoke one or more algorithms in order to determine the reference price for a medical service, to calculate a rebate to be given to a policy holder, to evaluate a price differential between the reference price for a medical service and a price paid by a policy holder for the medical service, or in order to accomplish some other task.

Determining the reference price for a medical service may be accomplished by selecting the reference price based at least in part on pricing information obtained for a plurality of local medical service providers. Local medical service providers may be medical service providers located within a desired distance from a set reference point which may be the policy holder's employment location, the policy holder's residence, a specified city, a specified building, a specified address, a specified medical service provider, or another specified area. In some cases, the desired distance may be about 5 miles, 10 miles, 20 miles, 30 miles, 40 miles, 50 miles, or some other distance. In an embodiment, local medical service providers may be medical service providers located within 35 miles of the reference point. Alternatively, the reference price for the medical service may be established by selecting the reference price from within a range of prices charged by a plurality of medical service providers for the medical service, selecting a price based upon an economic incentive, choosing a price for the medical service corresponding to a desired quality of the medical service, or by another method.

The reference price for the medical service may be stored in the database 210. The database 210 may be used to store reference prices for a selected list of medical services, pricing information from a plurality of medical service providers, and/or information about the quality of the medical service provided by the plurality of medical service providers. The application 220 may further be used to calculate the rebate to be paid to a policy holder upon purchase of a medical service priced lower than that service's reference price.

In an embodiment, the healthcare management system 200 may be configured such that the server 230 is connected to the database 210 and to the network 250, wherein the network 250 is further connected to the account 240 and the computer 260. In some embodiments, the account 240 may be a policy holder's bank account, savings account, medical savings account, loyalty account, rewards account, or any other value associated account in which a refund, rebate, award, reward, or other incentive may be delivered, deposited, and/or placed. It is contemplated that the computer 260 may be used to convey the price of a medical service purchased by the policy holder, information about the policy holder's healthcare plan, or other data to the server 230. The computer 260 may be embodied as a desktop computer, a laptop computer, a mobile electronic device, or as another suitable device.

In an embodiment, a policy holder may purchase a medical service at a healthcare location. An employee at the healthcare location may input data relating to the purchased medical service into the computer 260 which may then convey said data across the network 250 to the server 230. The data may comprise the price paid by the policy holder for the purchased medical service. The server 230 may use the application 220 to compare the price paid by the policy holder for the medical service to the reference price for the medical service stored in the database 210. The application 220 may determine the price differential between the reference price and the price paid by the policy holder. If the price paid by the policy holder is less than the reference price, then the application 220 may determine a rebate to be paid to the policy holder. The rebate may be a percentage of the savings from shopping below the reference price, it may be a fixed amount, or it may be some other amount. The server 230 may send rebate data over the network 250 to the account 240. In an embodiment, the rebate may be sent directly to the policy holder's bank account. The rebate may be applied over various time frames. For example, the policy holder may receive a rebate for shopping below the reference price for a medical service in the current billing cycle, quarterly, bi-annually, yearly, monthly, every week, or after some other period of time.

In another embodiment, the computer 260 may be operated by an insurance agent. The computer 260 may send data relating to a policy holder's healthcare choices and healthcare plan across the network 250 to the server 230. The application 220 may then process this information using information stored in the database 210. If the policy holder is obtaining medical services below the reference price for those services, then a rebate may be delivered to the policy holder's account 240.

In an embodiment, the computer 260 may be operated by a policy holder. In some cases, the policy holder may use the computer 260 to access the database 210 via the network 250. In accessing the database 210, the policy holder may be able to view the reference price for at least one medical service. If a shared savings rebate is implemented by an entity seeking to reduce healthcare costs associated with providing healthcare to policy holders, the policy holder may consult the database 210 in order to make an informed decision about his/her healthcare choices. The policy holder may use the computer 260 to send information relating to his/her healthcare policy to the server 230 through the network 250. Said information may be used to calculate a rebate to be delivered to the account 240 as described above.

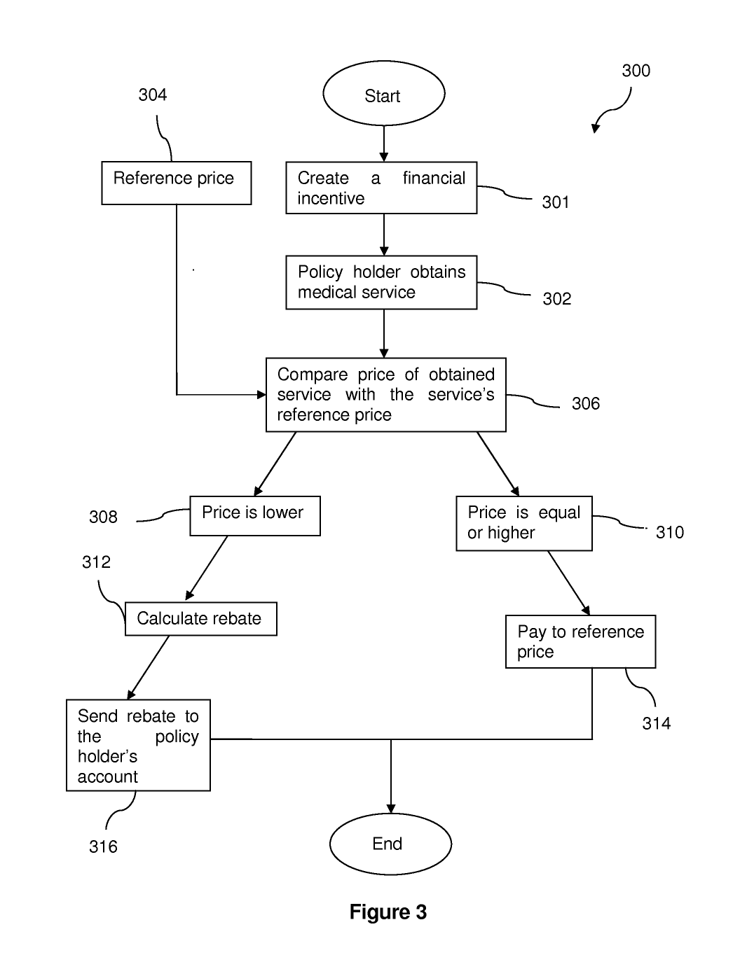

Turning now to FIG. 3, a method 300 is described. At block 301, a financial incentive is created. Economical behavior by a policy holder may help an entity manage healthcare costs associated with providing healthcare to policy holders. In some cases, the financial incentive may help to provide motivation for the policy holder to be economical when seeking medical treatment. In an embodiment, the financial incentive may be in the form of an incentive engine configured to incentivize the policy holder to obtain the medical service at a price lower than the reference price for the medical service, wherein the incentive engine may be a reward program in which the policy holder accumulates credit toward a reward given at the end of a cycle when the policy holder obtains the medical service at a price lower than the reference price for the medical service. The reward may be a shared savings rebate based upon a percentage of the savings, attributable to the policy holder shopping below the reference price, that the entity realizes, it may be a fixed amount, it may be a rate reduction, it may be cash back, it may be a discount, or it may be some other financial incentive.

There may be a number of qualified healthcare providers available to provide a medical service. While there may be little, if any, difference in the quality of the medical service provided by each of the healthcare providers, there may be a price difference between the healthcare providers. By incenting the policy holder to research the available providers, the mutually beneficial result of reducing the cost of healthcare, without reducing the quality of the healthcare, may be achieved.

At block 304, a reference price for a medical service is set. The entity may determine a reference price for a given medical service and agree to pay up to that price once a policy holder is past the deductible phase of his/her healthcare plan. In some cases, the reference price may be determined by an algorithm configured to calculate an acceptable price for a medical service based upon a range of known prices for the medical service, industry price surveys, an economic parameter, or based upon a desired quality for the medical service. In other cases, the reference price may be determined based upon other factors.

At block 302, the policy holder purchases a medical service. Based on the incentive described above, the policy holder may modify his/her purchasing behavior accordingly. In an embodiment, the financial incentive may be in the form of a rebate determined by the difference between the reference price of the medical service and the price paid for the medical service. The policy holder may be motivated to purchase less costly health services when he/she knows that he/she may receive a portion of the savings. In some cases, the policy holder may be motivated by the financial incentive to obtain the medical service at a lower price. In this case, the entity may reduce its cost of providing healthcare thereby managing its healthcare costs. At block 306, the entity may then compare the price of the purchased medical service with the reference price for that medical service.

If the price the policy holder paid for the medical service is equal to or above the reference price for that service, then the entity may pay up to the reference price as shown in blocks 310 and 314. If the policy holder purchases a medical service that meets or exceeds the reference price set for that medical service, then the policy holder may not receive a rebate. If the price the policy holder paid for the medical service is less than the reference price for that service, then the entity may calculate a rebate to be paid to the policy holder's account as shown in blocks 308, 312 and 316.

In an embodiment, the entity may only send the rebate to the policy holder's account after a pre-determined amount of time. For example, rebates may be delivered to the policy holder's bank account quarterly, semi-annually, yearly, monthly, every week, at the time of analysis indicating that the policy holder obtained the medical service at a price less than the reference price for the medical service, or after some other amount of time. In a case of delayed delivery of the rebate to the policy holder's bank account, the entity may keep track of a net rebate to be paid to the policy holder and deliver the net rebate after the pre-determined amount of time has passed. In an embodiment, the policy holder may wish to put the accumulating net rebate towards a medical service rather than receive a bank deposit. In this case, the amount of the accumulating net rebate put towards the medical service may be subtracted from the net rebate to be deposited in the policy holder's bank account after the pre-determined amount of time. It is contemplated that the entity may choose not to deposit the rebate in the policy holder's bank account; instead, the entity may deliver the rebate to the policy holder in the form of a check, cash, a gift card, or the rebate may be delivered by another method of payment. The alternate payment methods described may also be subject to delivery only after a pre-determined amount of time.

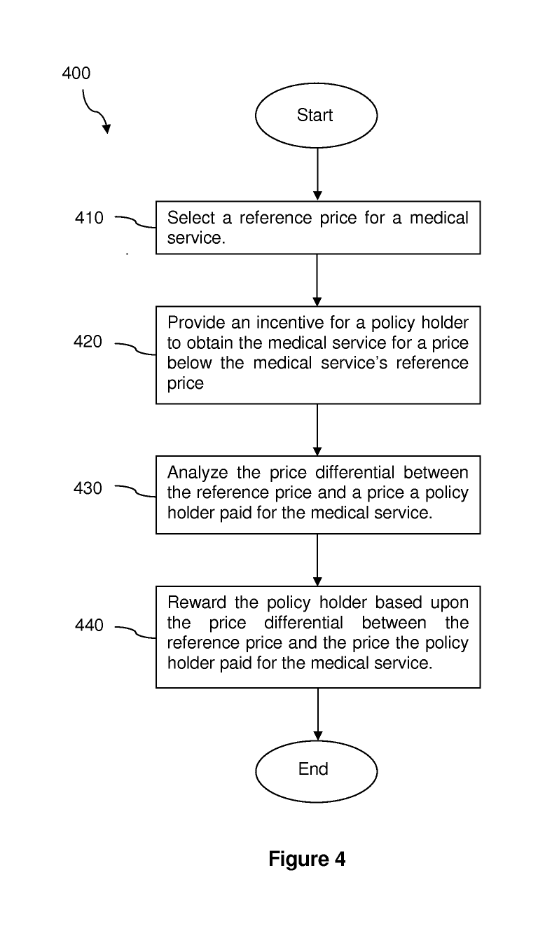

Turning now to FIG. 4, a method 400 is described. The flowchart comprises blocks 410, 420, 430, and 440 which describe steps in the method for sustaining healthcare consumerism 400. At block 410, a reference price is set for a medical service. At block 420, an incentive is provided for a policy holder to obtain the medical service at a price below the medical service's reference price. The incentive may serve to provide motivation for a policy holder to consume cost effective health services. Consumption of cost effective health services may result in an entity experiencing a reduction in the cost associated with providing healthcare benefits. At block 430, the price differential between the reference price and a price the policy holder paid for the medical service is analyzed. At block 440, the policy holder is rewarded based upon the price differential between the reference price and the price the policy holder paid for the medical service.

In some contexts, the reference price disclosed in block 410 may be described as a price threshold that an insurance entity has agreed to pay to. In an embodiment, the incentive detailed in block 420 may be a shared savings rebate calculated from the difference in price between the reference price for a medical service and a price paid for that medical service. In an embodiment, rewarding a policy holder, as described in block 440, may comprise delivering a rebate to the policy holder. Said rebate may be deposited in the policy holder's account 240, or the policy holder may receive the rebate directly via a check, cash, a gift card, or the policy holder may receive the rebate via another method.

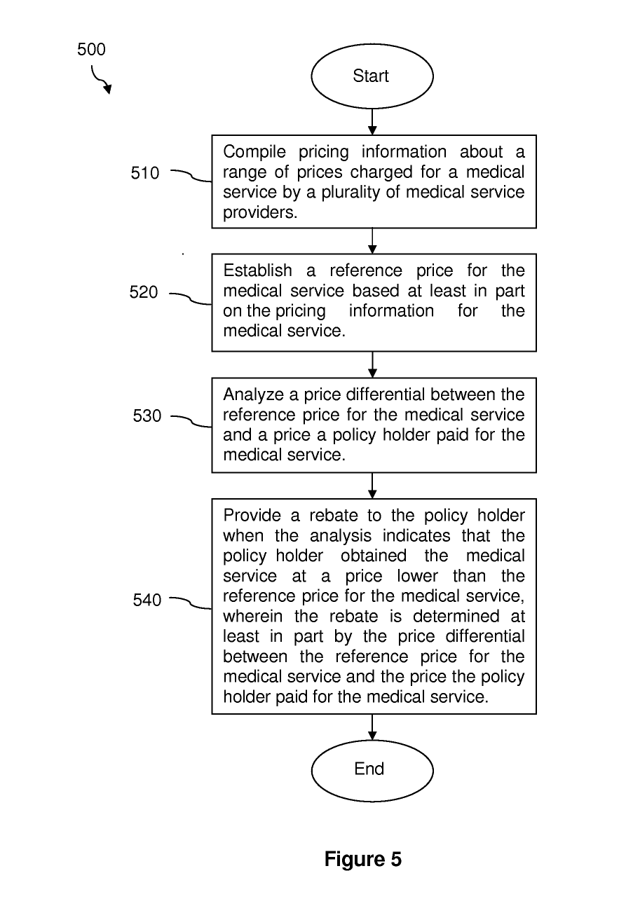

Referring to FIG. 5, a method 500 is described. At block 510, pricing information about a range of prices charged for a medical service by a plurality of medical service providers is compiled. A reference price for the medical service is established at block 520 based at least in part on the pricing information for the medical service. In an embodiment, an application may be used to analyze the pricing information and come up with the reference price according to guidelines set forth by a policy provider. At block 530, a price differential between the reference price for the medical service and a price a policy holder paid for the medical service is analyzed. At block 540, a rebate is provided to the policy holder when the analysis indicates that the policy holder obtained the medical service at a price lower than the reference price for the medical service, wherein the rebate is determined at least in part by the price differential between the reference price for the medical service and the price the policy holder paid for the medical service. Though the systems and methods described herein have been discussed in relation to managing the costs associated with providing healthcare, one skilled in the art will appreciate that the teachings of the present disclosure may be applied to other fields as well.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

It is understood that by programming and/or loading executable instructions onto the computer system 100, at least one of the CPU 110, the RAM 116, and the ROM 118 are changed, transforming the computer system 100 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 114 is typically comprised of one or more disk drives or tape drives and is used for non-volatile storage of data and as an over-flow data storage device if RAM 116 is not large enough to hold all working data. Secondary storage 114 may be used to store programs which are loaded into RAM 116 when such programs are selected for execution. The ROM 118 is used to store instructions and perhaps data which are read during program execution. ROM 118 is a non-volatile memory device which typically has a small memory capacity relative to the larger memory capacity of secondary storage 114. The RAM 116 is used to store volatile data and perhaps to store instructions. Access to both ROM 118 and RAM 116 is typically faster than to secondary storage 114. The secondary storage 114, the RAM 116, and/or the ROM 118 may be referred to in some contexts as computer readable storage media and/or non-transitory computer readable media.

I/O devices 112 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 120 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 120 may enable the processor 110 to communicate with the Internet or one or more intranets. With such a network connection, it is contemplated that the processor 110 might receive information from the network, or might output information to the network in the course of performing the above-described method steps. Such information, which is often represented as a sequence of instructions to be executed using processor 110, may be received from and outputted to the network, for example, in the form of a computer data signal embodied in a carrier wave.

Such information, which may include data or instructions to be executed using processor 110 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 110 executes instructions, codes, computer programs, scripts which it accesses from hard disk, floppy disk, optical disk (these various disk based systems may all be considered secondary storage 114), ROM 118, RAM 116, or the network connectivity devices 120. While only one processor 110 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 114, for example, hard drives, floppy disks, optical disks, and/or other device, the ROM 118, and/or the RAM 116 may be referred to in some contexts as non-transitory instructions and/or non-transitory information.

In an embodiment, the computer system 100 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 100 to provide the functionality of a number of servers that is not directly bound to the number of computers in the computer system 100. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 100, at least portions of the contents of the computer program product to the secondary storage 114, to the ROM 118, to the RAM 116, and/or to other non-volatile memory and volatile memory of the computer system 100. The processor 110 may process the executable instructions and/or data structures in part by directly accessing the computer program product, for example by reading from a CD-ROM disk inserted into a disk drive peripheral of the computer system 100. Alternatively, the processor 110 may process the executable instructions and/or data structures by remotely accessing the computer program product, for example by downloading the executable instructions and/or data structures from a remote server through the network connectivity devices 120. The computer program product may comprise instructions that promote the loading and/or copying of data, data structures, files, and/or executable instructions to the secondary storage 114, to the ROM 118, to the RAM 116, and/or to other non-volatile memory and volatile memory of the computer system 100.

In some contexts, the secondary storage 114, the ROM 118, and the RAM 116 may be referred to as a non-transitory computer readable medium or a computer readable storage media. A dynamic RAM embodiment of the RAM 116, likewise, may be referred to as a non-transitory computer readable medium in that while the dynamic RAM receives electrical power and is operated in accordance with its design, for example during a period of time during which the computer 100 is turned on and operational, the dynamic RAM stores information that is written to it. Similarly, the processor 110 may comprise an internal RAM, an internal ROM, a cache memory, and/or other internal non-transitory storage blocks, sections, or components that may be referred to in some contexts as non-transitory computer readable media or computer readable storage media.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer implemented system for sustaining healthcare consumerism comprising:
a database, wherein the database contains pricing information for a medical service;
a reference price for the medical service;
an application configured to determine the reference price for the medical service; and
an incentive engine configured to incentivize a policy holder to obtain the medical service at a price lower than the reference price for the medical service.

2. The computer implemented system of claim 1, further comprising:
an algorithm, performed by the application, configured to establish the reference price for the medical service based at least in part on a range of prices charged for the medical service by a plurality of medical service providers.

3. The computer implemented system of claim 1, wherein the database further contains the reference price for the medical service.

4. The computer implemented system of claim 1, wherein the pricing information contained in the database is information about a range of prices charged for the medical service by a plurality of medical service providers.

5. The computer implemented system of claim 1, wherein the incentive engine is a reward program, wherein the policy holder accumulates credit toward a reward given at the end of a cycle when the policy holder obtains the medical service at a price lower than the reference price for the medical service.

6. The computer implemented system of claim 5, wherein the reward is one of a rebate, receiving a percentage of the price differential between the reference price for the medical service and the price paid for the medical service, cash back, a rate reduction, or a discount.

7. A computer implemented method for sustaining healthcare consumerism comprising:
compiling pricing information about a range of prices charged for a medical service by a plurality of medical service providers;
establishing a reference price for the medical service based at least in part on the pricing information for the medical service;
analyzing a price differential between the reference price for the medical service and a price a policy holder paid for the medical service; and
providing a rebate to the policy holder when the analysis indicates that the policy holder obtained the medical service at a price lower than the reference price for the medical service, wherein the rebate is determined at least in part by the price differential between the reference price for the medical service and the price the policy holder paid for the medical service.

8. The method of claim 7, wherein the reference price is established by an algorithm.

9. The method of claim 7, wherein the rebate is provided to the policy holder at the end of a cycle.

10. The method of claim 9, wherein the end of the cycle occurs at the end of the year, at the end of the plan year, semi-annually, quarterly, monthly, weekly, or at the time of the analysis.

11. The method of claim 7, wherein the reference price is established based at least in part on pricing information limited to a plurality of local medical service providers.

12. The method of claim 11, wherein local medical service providers are medical service providers located within 35 miles of the policy holder's place of residence.

13. The method of claim 11, wherein local medical service providers are medical service providers located within 35 miles of a reference point which may be the policy holder's employment location, a specified city, a specified building, a specified address, a specified medical service provider, or another specified area.

14. A computer implemented system for managing healthcare costs comprising:
a database, wherein the database contains pricing information for a medical service;
a reference price for the medical service;
an algorithm configured to establish the reference price for the medical service;
an application configured to perform the algorithm; and
an incentive configured to incentivize a policy holder to obtain the medical service at a price lower than the reference price for the medical service.

15. The computer implemented system of claim 14, wherein the incentive is a reward that is one of a rebate, receiving a percentage of the price differential between the reference price for the medical service and the price paid for the medical service, cash back, a rate reduction, a discount, or some other reward given to the policy holder for obtaining the medical service at the price lower than the reference price for the medical service.

16. The computer implemented system of claim 15, wherein the policy holder accumulates credit toward the reward by obtaining the medical service at the price lower than the reference price for the medical service, wherein the policy holder's total credit at the end of a cycle is used to determine the reward given to the policy holder.

17. The computer implemented system of claim 16, wherein the end of the cycle occurs at the end of the year, at the end of the plan year, semi-annually, quarterly, monthly, weekly, or at the time of the analysis.

18. The computer implemented system of claim 14, wherein the algorithm establishes the reference price for the medical service based at least in part on the pricing information for the medical service stored in the database.

19. The computer implemented system of claim 14, wherein the application is further configured to calculate a rebate payable to the policy holder.

20. The computer implemented system of claim 14, wherein the algorithm establishes the reference price for the medical service based at least in part on an evaluation of a plurality of medical service providers, wherein the evaluation considers the quality and price of the medical service provided by each of the medical service providers.
